(19) United States
(12) Patent Application Publication
(10) Pub. No.: US 2004/0071902 A1
(43) Pub. Date: Apr. 15, 2004

(54) Biocide containing laminate as tape or packaging material

(76) Inventor: Thomas Robert Santelli, Zionsville, IN (US)

Correspondence Address: WINSTON & STRAWN, PATENT DEPARTMENT, 1400 L STREET, N.W., WASHINGTON, DC, 20005-3502, US

(21) Appl. No.: 10/261,960

(22) Filed: Oct. 1, 2002

(51) Int. Cl. B32B 1/02

(52) U.S. Cl. 428/34.2; 156/272.6

(57) ABSTRACT

A biocide containing laminate for use in the construction of a wide variety of products. A preferred product is a pouch or other container for forming an envelope protectively packaging a product such as a flowable or solid food substance. The pouch is fabricated from a paper-plastic laminate sheeting whose plies have different properties that depend on package requirements, at least one ply in the laminate being an oriented, synthetic plastic film of high tensile strength. The plies are adhesively laminated at ambient temperature with a water-based adhesive whereby the orientation of the film is unaffected by the laminating process, in the course of which no environmentally objectionable fumes are discharged into the atmosphere. The biocide is associated with the paper material or water-based adhesive of the laminate in an amount sufficient to render it resistant to attack from organisms. The plastic film protects and retains the biocide in the laminate. The laminate may be made into an organism-resistant tape, a water-resistant envelope, or a package for mailing various materials.

### BACKGROUND ART

The invention relates generally to biocide containing laminates for use in a wide variety of products, including pouches or containers forming an envelope for protectively packaging food substances, written materials, and other products. The laminate includes a layer of paper and at least one ply of an oriented synthetic plastic film that imparts high strength and tear resistance. Other products bags and other dilatable container products that initially are in a flat state and are normally made of paper, or tape or other adhesive-backed laminate sheetings.

Pouches or containers for storing and dispensing flowable or solid food substances and other more or less perishable products are usually fabricated of a multi-ply laminate sheeting forming an envelope to protect the contents of the package and prolong its shelf life. The shelf life of a packaged product depends on the degree to which it is isolated from the atmosphere in which the package is placed.

One well-known form of pouch serves to package a condiment such as mustard, ketchup or a hot dog relish, which is dispensed by tearing an opening in the pouch and then squeezing the pouch to extrude the condiment therefrom. This pouch is formed of a laminate sheeting whose outer ply is a clear polyester film, the inner face of which is printed to identify the contents. The outer film ply is adhesively laminated to an intermediate ply of metal foil that in turn is adhesively laminated to an inner ply formed of polyethylene film.

The three plies that together create this laminate sheeting have distinctly different properties. The outer polyester film ply imparts strength and tear resistance to the pouch, the intermediate metal face ply acts as a moisture barrier, while the inner polyethylene ply facilitates sealing of the pouch.

The reason that a metal foil or a metallized plastic film is often included in laminate sheeting from which a pouch is fabricated to package food is because plastic films, even those of exceptional tensile strength, have some degree of porosity. As a consequence, a pouch formed entirely of plastic film material will exhibit a moisture vapor transmission rate (MVTR) that is often unsuitable in a food container. The transfer of moisture through the envelope of a food pouch reduces its shelf life, and a moisture barrier is therefore desirable.

A serious drawback of multi-ply laminate sheeting of the type heretofore used for fabricating pouches and other packaging material, does not entirely reside in the structure of the sheeting, but rather in the environmental conditions which prevail in the course of producing the sheeting.

Most industrial adhesives used to interlaminate the several plies of the laminate sheeting include volatile chemical solvents that in the course of curing the adhesive are volatilized. The resultant noxious fumes that are driven off into the atmosphere are environmentally objectionable. It becomes necessary, therefore, in the plant in which the pouch laminate sheeting is produced, to provide filtration and other equipment to capture and treat the noxious fumes. This requirement adds substantially to the cost of production.

In those instances where hot melt adhesives are used to join the plies of a laminate sheeting, not only do some of these adhesives give off objectionable fumes, but the heat involved may have adverse effect on the plies to which the hot melt adhesive is applied. Thus, if one of the plies is a synthetic plastic film that has been uni-axially or bi-axially oriented to enhance its tensile strength, this orientation will be impaired by heat, for heat acts to relax the film and in doing so, to destroy its orientation and strength.

Of background interest are U.S. Pat. No. 4,790,429 to Fukushima and U.S. Pat. Nos. 3,989,640 and 4,724,982 to Redmond. These patents disclose various forms of pouches and containers for food products formed of plastic film material. The food pouch disclosed in U.S. Pat. No. 3,366,229 to Sanni uses a laminated sheeting of thermoplastic film and paper so that seal lines can be produced by thermal welding. U.S. Pat. No. 4,806,398 to Martin shows a carton for liquid formed by a paper substrate having bonded to one side a polyethylene film and to the other side a polyolefin film to provide a liquid-impermeable laminate that lends itself to thermal bonding. A similar container is shown in U.S. Pat. No. 3,404,988 to Rawing

There is also a need for materials that can be used for packaging or mailing of various items. In the past, such materials were made from plastics or Kraft or other paper, the latter optionally coated with polymers or plastic films. The plastics or polymers provide resistance to moisture, such as would be encountered from rain or snow during times when the package is being shipped.

The sheeting traditionally used in making packaging materials such as envelopes, grocery bags and other types of dilatable container products that initially are in a flat state, is paper. Paper is a semi-synthetic material made by chemically processing cellulose fibers. Apart from its low cost, an important advantage of paper is that it can be converted into envelopes and other types of dilatable container products by means of high speed equipment that functions to cut and fold the sheeting into the desired configuration, the folds and flaps of the product being bonded together, where necessary, by standard low-cost adhesives. Another advantage of paper in this context is that it can readily be printed and colored, using standard inks for this purpose. But such paper products suffer from several disadvantages, for they are characterized by low tear and burst strength, and are by no means water resistant; for unless coated, paper is highly absorbent.

A number of packaging products have been made from materials that are paper-based but that have greater strength or durability. These products are made of heavy weight paper and cardboard or other pressed paperboard products. Corrugations or other configurations can be used to further strengthen the product without adding excessive weight. While these products are useful for a variety of applications, they still have deficiencies in that the cardboard materials can be damaged by impact and moisture. Of course, when wet, the material can deteriorate or be damaged more easily. For these reasons, cardboard packaging products can be coated with a moisture-resistant or water-repellant coating, but this significantly increases the costs of such products.

Also well known in the art are plastic-coated cellulosic papers, these being used chiefly in children's books, posters, signs and shipping tags, and for other purposes demanding resistance to hard wear and to outdoor exposure. Such plastic-coated papers lack high tear and burst strength. Also low in strength are special purpose coated papers covered on one or both sides with a suspension of clays, starches, rosin or wax, or a combination of these substances. To overcome the drawbacks of paper-fabricated dilatable container products, in recent years such products have been made of TYVEC or other polymeric synthetic plastic sheeting. The resultant products not only have a tear and bursting strength far superior to paper, but they are also waterproof. But TYVEC and similar synthetic plastic sheeting materials are difficult to convert into envelopes and other dilatable container products using high-speed equipment of the type mainly suitable for paper. As a consequence, production scrap rates can run as high as thirty percent, thereby raising the cost of manufacturing these products. Moreover, such plastic sheeting has a low chemical affinity for standard adhesives; hence in the case of envelopes, one must then use a special and more costly adhesive on the flaps. And such plastic sheeting also has a low affinity for standard printing inks, and the products, therefore, demand special printing inks for this purpose.

One particular packaging material that resolves many of these problems is disclosed in U.S. Pat. No. 5,244,702 to Finestone et al., where an envelope is made from a laminate of a plastic film that is adhesively cold laminated between two layers of paper. The paper layers enable the laminate to be printed, colored or marked with indicia, while the plastic film provides resistance to tearing and resistance to deterioration by contact with moisture or rough handling.

While the envelope materials of the Finestone et al. patent are suitable for many applications, there are situations when the contents of the package must be protected from organisms such as insects, bacteria or other contaminants that can deleteriously affect products that are packaged with such materials, and in particular, food products.

Certain packaging materials have been made with biocidal materials in an attempt to protect the contents of the package from such organisms. For example, US Pat. No. 4,988,236 discloses a polymeric tape that includes a biocide that is incorporated in the polymer in an amount effective to provide biocidal activity on the surface of the tape. Typically, the biocide is added to polymer pellets and the film is formed from the mixture. The resulting biocide containing film is generally used as an outer layer of the tape so that the biocide can leach from the polymer after the tape is applied to a package. This material has disadvantages in that the addition of the biocide to the polymer that is used to form the film reduces the properties of the resultant polymer film.

Also, U.S. patent application Ser. No. 2001/0041238 A1 discloses an adhesive coated, peelable protective films and labels, wherein the adhesive may contain among many other components, a biocide. While the addition of a biocide to an adhesive is a more convenient way to incorporate it into the tape, it can be removed when the adhesive is activated for application to a package or the like.

Thus, there remains a need for improved packaging materials or tapes that contain biocides. In addition, the resulting materials or tapes should be resistant to moisture while still being capable of receiving printing or other marking indicia. The present invention now provides new materials that satisfy all these needs.

### SUMMARY OF THE INVENTION

The present invention now provides a method for making an organism-resistant laminate of plastic and paper. This method includes the steps of providing a plastic film having first and second sides; corona discharge treating the first side of the plastic film; providing a paper sheet having first and second sides; adhesively cold laminating the corona discharge treated first side of the plastic film to the first side of the paper sheet using a water-based adhesive and pressure to form a paper-plastic laminate; and associating a biocide with the laminate in an amount sufficient to render it resistant to attack from organisms. The useful biocides include bacteriocides, fungicides, pesticides, moldicides, mildicides or viricides.

In one embodiment, the biocide is associated with the paper sheet before the laminate is prepared. This is conveniently achieved by contacting the paper sheet with an aqueous solution or suspension of the biocide and then drying the paper sheet. In another embodiment, the biocide is associated with the water-based adhesive that is utilized to cold laminate the plastic film to the paper sheet. This may be accomplished by combining an aqueous solution or suspension of the biocide with the adhesive to make a biocide containing adhesive mixture before utilizing the mixture to cold laminate the plastic film and paper sheet together.

A paper-plastic-paper laminate can be prepared by corona discharge treating the second side of the plastic film; and adhesively cold laminating the corona discharge treated second side of the plastic film to a side of a second paper sheet using a water-based adhesive and pressure. This laminate can be used as is as a packaging material, or one of its outer surfaces can include an adhesive after treatment of that surface by corona discharge. Any type of adhesive can be applied.

The invention also relates to the biocide containing laminates described herein as well as to the use of those laminates as organism-resistant packaging materials. A preferred use of the material is as an organism-resistant package where the laminate is configured and dimensioned as an envelope, packaging material, or container. In this embodiment, the laminate can be folded to form the envelope or container and an adhesive applied to one or more portions of the folded laminate to facilitate closure and/or sealing.

A preferred embodiment of the package is as a container of a dilatable material that is configured and dimensioned to retain one or more articles therein and which includes the laminate described herein with applied adhesive to close and seal the article(s) in the container. The dilatable material may be a cardboard box having flaps that are folded to form the box and the laminate in the form of a tape product is applied to secure the flaps and seal the articles in the box. Instead, the laminate of dilatable material may be in the form of an envelope or container with adhesive being applied thereto for forming a closing portion for the envelope or container. The package may include two superposed panels of the laminate that are marginally sealed together to define a pocket to accommodate the article(s).

The laminate may also be formed into a tape by applying an adhesive to all or a portion of one of the surfaces of the laminate. Also, the laminate can be cut to the desired size for use as a tape. When a paper/plastic laminate is used, the adhesive can be simply applied to the second surface of the paper sheet, or to the second side of the plastic film after corona discharge treating that side of the film. For a plastic/paper/plastic laminate, the adhesive can be applied to an outer surface of one of the plastic films after corona discharge treating that film. Preferred adhesives include a water-moistenable adhesive, a pressure sensitive adhesive, a heat activated adhesive, or a cohesive adhesive.

### DETAILED DESCRIPTION OF THE PREFERRED EMBODIMENTS

The present invention discloses desirable laminate structures which have a biocide associated with the laminate such that it can be used as packaging material or as packaging tape with enhanced performance compared to laminates or tapes that do not contain a biocide. This renders the material eminently suitable for packaging food items or other perishable commodities while protecting them from attack or deterioration cause by various organisms.

In this specification, the term “organism” is used to mean an animal, insect or other pest, bacterium, fungus, mold, mildew, virus or other biological contaminant that can detrimentally affect a food or similar perishable commodity, while the term “biocide” is used to refer to any agent such as an insecticide, pesticide, fungicide, moldicide, mildicide or viricide, which can eradicate, eliminate or ward off such organisms. Organic biocides, such as alkali salts of organic acids such as benzoic, acetic and the like can be used, with sodium acetate and sodium benzoate being particularly preferred. Also, inorganic biocides include the inorganic salts of oxidizing agents, such as sodium chlorate. Arsenic compounds, organophosphorous compounds, heavy metal compounds, sulfur compounds and tin compounds are suitable as biocidal components. Those of ordinary skill in the art can select the desired biocide for the intended use of the biocide containing laminate as well as for its intended incorporation in the final article.

The biocide can be associated with the laminate in any one of a variety of ways, so that an amount is present which is effective to render the laminate resistant to attack by such organisms. The specific method for associating the biocide with the laminate will vary depending upon the form of the laminate.

In one embodiment, a paper-plastic laminate is used. This laminate is formed by cold laminating a paper ply to a plastic film that has been treated by a corona discharge to render it receptive to adhesives. The paper that is used to form these laminates can be any kind of paper, which includes coated paper, Kraft paper, or a higher quality paper such as Bond or white paper. These papers generally have a thickness of from about 3 to 6 mils although other thicknesses can be used for certain specialty applications.

A single plastic film is adhesively cold laminate to the paper to form the laminate. The plastic film that is used is preferably a polymer and is most preferably polypropylene, polyethylene or polyester. It typically has a thickness of from about 0.5 to about 3 mils although other thicknesses can be used without departing from the teachings of the invention. It is advantageous to use a plastic film that is oriented, and preferably biaxially-oriented, so that it can provide exceptional tensile and burst strengths. Such orientation is effected by stretching the film along at least one and preferably both of their transverse and horizontal axes to molecularly orient the film structure. Preferred plastic materials include polypropylene or polyester (i.e., MYLAR). The resultant oriented films material have a sufficiently high tensile strength to easily and securely retain materials within the package or container during shipping and handling.

In order to join the plastic film to the paper web, the surface of the plastic film that is to be laminated to the paper is corona-discharge treated. This treatment is applied to the plastic film immediately before the corona discharge treated surface is adhesively cold laminated to the paper web. This enables a strong bond to be achieved between the plastic and paper in the laminate.

The cold lamination process enables the present laminate material to be manufactured at much higher speeds than when other adhesives, such as hot melt adhesives, are utilized, due to the additional time required for cooling of the hot melt adhesive before a secure bond is achieved. If hot melt adhesives were used instead of cold lamination for joining the plastic film to the paper, the heat of the adhesive could also cause the film to shrink, thus causing a loss of strength. Also, hot melt adhesives do not achieve a final bond strength until the adhesive cools, and the plastic film can shrink before this happens. Moreover, a wrinkled or curled product often results due to the difference in the high strength and low strength areas of the plastic film.

The use of cold lamination is especially advantageous when an oriented or biaxially-oriented plastic film is utilized. It is known that at elevated temperatures, such films relax and lose molecular orientation and strength. For example, when two sheets of biaxially-oriented polyester film are seamed together, using an ultrasonically-activated sealing bar to create internal friction and heat within the film, the films soften and fuse, with a resultant sealing line that is weak, such that the sheets then tend to tear along this line. Similar problems are encountered if an oriented film is exposed to high heat, such as if a hot melt adhesive would be used to join the film to the paper.

Accordingly, cold lamination utilizing a water-based adhesive is essential in order to produce a laminate that has high strength. The paper layer absorbs the water from this adhesive system so that a high strength lamination can be rapidly achieved. While any water-based adhesive can be used to make this type of high strength bond, it has now been found that a formulation that rapidly sets to provide initial tack to the adhesive is necessary. Suitable initial tack means that the adhesive can hold an oriented plastic film in position against the paper web without slippage within 10 seconds of application of the adhesive, and preferably within about 5 seconds. Essentially instantaneous tack is highly desirable, since this enables even faster production speeds to be utilized. U.S. Pat. No. 5,244,702 provides further details on this cold lamination process, and is incorporated herein to the extent necessary to further understand this feature of the invention. If a rapidly setting adhesive is used, however, much higher production speeds can be achieved.

In another embodiment, a plastic/paper/plastic laminate is used. The same paper layer described above is used, with a plastic film adhesively cold laminated to each side of the paper. The plastic films that are used to form the outer layers of these laminates is the same as those described above for the paper/plastic laminate.

In yet another embodiment, two plastic films can be cold laminated together after the facing sides of each film are corona-discharge treated. These can be joined together as disclosed in U.S. Pat. No. 6,348,246, the entire content of which is expressly incorporated herein by reference.

When two plastic films are present in the laminate, the cold lamination process is much more useful compared to other processes to make such laminates. For example, organic solvent based adhesives cannot be used because there is no outlet for the solvent to evaporate from the laminate. Also, certain solvents can attack and soften the plastic films to cause loss of strength. The adverse health and environmental effects are avoided because such solvents are not used. Also, additional costs for recovering or disposing of solvents are not incurred.

In any of the embodiments that include a paper layer, the biocide can be applied to the paper layer before cold laminating it to the plastic film or films. An aqueous solution of the biocide can be made and the paper can be dipped into, or sprayed or brushed with the solution. The concentration of the biocide in the solution should be such that a sufficient amount is present in the paper to prevent attack by the organism. One of ordinary skill in the art can determine by routine testing as to how much of the biocide is needed depending upon the type and properties of the specific compound that is used. The particular amount to be used can be determined by routine testing, but would be on the order of about 1 ppm to about 5% by weight of the laminate, and preferably about 100 ppm to about 1% by weight of the laminate. The biocide does not have to be fully dissolved in the solution, as a suspension, dispersion or other mixture of the biocide is also suitable. Whether the mixture of biocide and water is a solution, suspension or dispersion depends somewhat upon the solubility of the particular biocide compound that is used. If necessary, a surfactant or other dispersing agent can be used to assist in keeping the biocide dispersed or dissolved in the solution so that it can be relatively uniformly applied and distributed onto or into the paper. After application, it is preferable for the paper to dry before being laminated as it is advantageously used to absorb some of the water from the water-based adhesive that is used for the cold lamination step.

Another way of associating the biocide with the laminate is to include it in the water that is used to prepare the water-based adhesive that is used for cold laminating a paper ply to a plastic film or for laminating two plastic films together. Again, the adhesive can be in the form of a solution, dispersion, suspension or other mixture, and surfactants or dispersing agents can be included if desired. In general, any of the adhesives disclosed in U.S. Pat. Nos. 5,244,702 or 5,686,180 can be utilized.

The incorporation of the biocide in the paper layer or in the adhesive that is used to join the paper layer to the plastic film enables the biocide to be protected in a central portion of the laminate. When incorporated in the paper layer and the bonding adhesive that is used to attach the laminate to a package is applied to the paper layer, the biocide containing paper is protected by the water-based adhesive and plastic film on one side and by the bonding adhesive on the other side. When incorporated in the water-based adhesive, the biocide-containing adhesive is protected by the paper layer on one side and the plastic film on the other side. Even when the bonding adhesive is applied to the plastic film and the biocide is incorporated into the paper, the exposed paper layer has better resistance to loss of biocide than if the biocide was applied to the bonding adhesive. This is particularly true when the biocide-containing paper is dried prior to formation of the laminate.

The water-based laminating adhesive is applied at an amount of about 4 to 10 pounds per ream of paper. Since the solids content of the adhesive is approximately 50%, the adhesive introduces approximately 2 to 5 pounds of water per ream of paper. The paper layer absorbs such moisture and enables the laminate to be prepared by simultaneous lamination. Also, the rapid setting and generation of tack by the preferred adhesives of the invention enables the oriented plastic films to adhere to the paper or each other without slippage or loss of stretch of the films.

Further details on the additional adhesives that can be utilized in this invention, along with their method of manufacture, can be found in U.S. Pat. No. 5,686,180, the content of which is expressly incorporated herein by reference thereto.

The method of manufacturing of the plastic-paper laminate is advantageously conducted in one step, with the plastic film being exposed to ionization on the surface that faces the paper web, the water-based adhesive is applied to the activated surface of the film, and then the film is applied to the paper web as they pass between the pressure rolls. U.S. Pat. No. 5,244,702 includes additional details about the manufacture of these type products, and is incorporated herein by reference to the extant necessary to understand such manufacturing details. Additional layers or plies can be added to the laminate as taught therein, i.e., that any plastic film surfaces to be joined are first corona-discharge treated while no special treatments are needed for the paper ply except to assure that it is somewhat dry before being laminated.

In certain specialty applications, an additional paper layer can be applied to one or both of the outer surfaces of the plastic films of the laminate. As the additional paper layer(s) form the inner and/or outer sides of the laminate material, they can easily be printed with graphics or other indicia. This enables the laminate material to have one appearance on the outside of the envelope and another, different appearance on the inside of the envelope.

Furthermore, the formation of a plastic-paper-plastic laminate enables the biocide to be incorporated in the paper layer or in one of the water-based laminating adhesives while being protected by the two outer plastic films.

If a decorative laminate material is desired, a metallization or aluminization step can be applied to one or both of the plastic films to provide a decorative finish. Also, when clear plastic is used for one or both of the films, the metallization can be applied to one or both surfaces of the paper layer and be viewable through the clear plastic film(s). One or both of the plastic films also can be metallized on the surface that is bonded to the paper so that the decorative finish is visible through the clear plastic film. If a silver finish is desired, an aluminized surface is preferred. Other metallizing treatments, e.g., with copper, iron, or alloys, can be used when other colors are desired. Also, the plastic films can be colored or tinted to provide additional color effects.

It may be desirable that the laminate be provided with printable surfaces so that logos, messages, advertisements, emblems, trademarks or simply, addressee information etc., may be printed on the exterior or interior surfaces of the laminate. In this regard, the paper ply layer includes printable surfaces. The laminate, if desired, may include a printable surface of metallized paper. Further, one or both of the plastic films may include a second corona discharge treated surface to render it receptive to inks so that it may exhibit graphics that may be desired. The outer surface of one or both of the plastic films may be metallized as by vacuum deposition to provide a decorative finish or to further provide a printable, decorative exterior.

After the laminate sheeting material is formed into the final product, an envelope for example, a flap can be provided with an adhesive band. The adhesive may be a standard starch adhesive or a pressure sensitive adhesive. Also, the band may be a layer of cohesive material and, if so, a corresponding band of cohesive material is applied onto the portion of the envelope that is contacted by the flap. Since the cohesive material only sticks to itself, the exposed bands of cohesive do not stick to other portions of the envelope. Thus, the envelopes can be stacked or otherwise collected and collated without concern of the envelopes sticking together and no barriers are required to prevent the envelopes sticking to itself or other envelopes when a plurality of envelopes are stacked and packaged.

The laminate sheeting material can be used as is as a packaging material and can be wrapped about an article or item to be shipped. The laminate can form a seal around the article if secured by tape. In particular, a tape made from the laminate of the invention is preferred since the article to be shipped would be sealed with biocide containing material wither in the form of a laminate or tape.

When a tape product is to be made, the laminate is provided with an adhesive on one of its outer sides. If the outer side is a paper layer, no special treatment is needed, while if it is a plastic film, it will be corona-discharge treated as described herein before the adhesive is applied. Any of a wide variety of adhesives can be used for this purpose, but water-moistenable, pressure-sensitive, or heat-activated adhesives are preferred. In some cases, a cohesive adhesive can be used if the material it be envelope a product and stick to itself. Also, the laminate sheeting itself can be provided with an adhesive on selected portions or all of one of its outer sides so that it can be adhere to itself or the article during wrapping of the package.

When multiple layer laminates are utilized, the biocide can be applied to any paper layer or to any water-based adhesive that is used to cold laminate the layers together. Multiple applications of the biocide may be preferred for certain applications where the highest degree of protection is desired.

When the laminate is used as a packaging material, a tear line or weakened portion can be provided to assist in opening the package. The laminate can also be provided in the form of a pouch that can retain a liquid or solid food therein. This pouch, though illustrative of a flexible container fabricated of laminate sheeting in accordance with the invention is by no means the only form of pouch that can be so produced. Thus, the pouch may be shaped and dimensioned to store potato chips, or candy and other solid food substances. Or the pouch or container formed of the laminate sheeting may be designed to envelop and protectively package other non-food products that are more or less perishable.

In these constructions the plastic layers generally provide resistance to moisture and a smooth surface for introducing items into the pouch or envelope or for handling the package. The paper layer can be preprinted with written material, colors, or other indicia on one or both sides so that information regarding the origination or mailer of the package or its manufacturer can be readily observed either as an outer layer or through the plastic layer. The paper layer can also be metallized on one or both sides for an enhanced appearance.

For products where it is important to securely maintain the product contents therein, the use of a container made form a laminate that has two layers of plastic and which is sealed by a laminate in the form of a tape is preferred. These can be used to retain foods that can be affected by biological contamination or to retain waste such as sanitary napkin or air sickness bags or bags used to convey medical wastes. The plastic films in the laminates prevent the entry or exit of liquid or moisture from the container as well as preventing the ingress or egress of biological organisms.

There may be certain situations where it is undesirable to have exposed interior or exterior plastic surfaces. These situations can be avoided by laminating additional paper layers to one or both of the exposed surfaces of the plastic films. These additional paper layers can be applied as described above with any of the laminates disclosed herein to thus provide final laminates of paper-plastic-plastic; paper-plastic-plastic-paper; paper-plastic-paper-plastic; or paper-plastic-paper-plastic-paper. This demonstrates the versatility of the invention in providing the most desirable form of the laminate for any particular use. These constructions provide even more locations where the biocide my be incorporated while being protected by outer layers of plastic or paper layers.

The salient advantages of the laminate in accordance with the invention include the waterproof properties of the resulting laminate, and the fact that the laminate can be converted into products by conventional equipment for this purpose with minimum scrap in a range in a range comparable to the scrap rate encountered in making paper envelopes and other dilatable container products. As paper sheets have a high affinity for standard printing inks, when these are included, the resulting laminate can readily be printed and colored. Also, when a paper layer or sheet is provided on the exterior surfaces, a standard starch or pressure-sensitive adhesive may be used on the flaps of envelopes formed of these laminates.

Certain food products require that the container in which they are shipped have some degree of breathability, and in those situations, the container is not made of the laminates of this invention. Instead, a conventional cardboard box may be used to hold the food product, and the laminate of the invention is made into a tape product that is used to seal the box to prevent or reduce the possibility of entrance of the organism. For example, a standard box that has four top and bottom flaps can be closed by folding the flaps and then is sealed by the application of the tape of the invention. Organisms cannot gain access to the food product through the spaces between the flaps as those are covered by the tape. In some instances, the laminate of the invention can be applied as an adhesive backed sheet to provide, e.g., moisture resistance to the bottom of the box for additional protection as it is shipped. In this embodiment, the laminate can be applied to either the inside or outside of the box. Thus, a wide range of container designs can be made combining conventional materials, such as cardboard, and laminates according to the invention.

Additional examples of products according to the invention include cardboard boxes of fruit, grains, vegetables or other foods where the boxes are sealed with a tape comprising one of the laminates of the invention that includes a pressure-sensitive adhesive backing. In addition, certain foods that are shipped in the box, e.g., bananas, can also be placed in pouches formed of one of the laminates of the invention. This provides the most secure protection of the product from the attack of organisms.

While embodiments of the invention have been shown and described, it will be appreciated that many changes may be made therein without departing from the spirit of the invention. For example, the plastic films themselves can be colored or clear. Coloration of the films can be made over the entire film or only on selective portions. Metallization of the films can be provided in the same manner. When clear plastic films are utilized alone in a plastic-plastic laminate, the contents of the envelope or pouch are visible so that the recipient can readily determine what is included therein. This can be used for safety or quality control purposes.

What is claimed is:

1. A method for making an organism-resistant laminate of a plastic film and a paper material which comprises:
providing a plastic film having first and second sides;
corona discharge treating the first side of the plastic film;
providing a paper material having first and second sides;
adhesively cold laminating the corona discharge treated first side of the plastic film to the first side of the paper material using a water-based adhesive and pressure to form a paper-plastic laminate; and
associating a biocide with the paper material or water-based adhesive of the laminate in an amount sufficient to render it resistant to attack from organisms,
wherein the plastic film assists in protecting and retaining the biocide in the laminate.

2. The method of claim 1, wherein the biocide is a bacteriocide, a fungicide, a pesticide, a moldicide, a mildicide or a viricide.

3. The method of claim 1, which further comprises associating the biocide with the paper material before the laminate is prepared.

4. The method of claim 3, which further comprises associating the biocide with the paper material by contacting the paper material with an aqueous solution or suspension of the biocide and then drying the paper material before forming the laminate.

5. The method of claim 1, which further comprises associating the biocide with the water-based adhesive that is utilized to cold laminate the plastic film to the paper material.

6. The method of claim 5, wherein an aqueous solution or suspension of the biocide is combined with the adhesive to make a biocide containing adhesive mixture before utilizing the mixture to cold laminate the plastic film and paper material together, such that the biocide is protected by both the plastic film and the paper material.

7. The method of claim 1, which further comprises forming a tape from the laminate by applying a bonding adhesive thereto.

8. The method of claim 7, wherein the bonding adhesive is applied to the second surface of the paper material.

9. The method of claim 7, which further comprises corona discharge treating the second side of the plastic film and applying the bonding adhesive to the corona discharge treated second side of the plastic film.

10. The method of claim 7, wherein the bonding adhesive is a water-moistenable adhesive, a pressure sensitive adhesive, or a heat activated adhesive.

11. The method of claim 1, which further comprises corona discharge treating the second side of the plastic film; and adhesively cold laminating the corona discharge treated second side of the plastic film to a side of a second paper material using a water-based adhesive and pressure to form a plastic-paper-plastic laminate, wherein the biocide is associated with the paper layer or with one of the water-based adhesives so that the plastic films protect and retain the biocide in the laminate.

12. The method of claim 1, wherein the paper material is a paper sheet, a pressed paper, or cardboard optionally provided with corrugations.

13. An organism-resistant laminate of a plastic film and a paper material comprising:
a paper material having first and second sides;
a plastic film having first and second sides, with the first side of the plastic film being corona discharge treated and adhesively cold laminated to the first side of the paper material using a water-based adhesive and pressure to form a paper-plastic laminate; and
a biocide associated with the paper material or water-based adhesive of the laminate in an amount sufficient to render it resistant to attack from organisms,
wherein the plastic film assists in retaining the biocide in the laminate.

14. The laminate of claim 13, wherein the biocide is a bacteriocide, a fungicide, a pesticide, a moldicide, a mildicide or a viricide.

15. The laminate of claim 13, wherein the biocide is associated with and carried by the paper material.

16. The laminate of claim 13, wherein the biocide is associated with and carried by the water-based adhesive that is utilized to cold laminate the plastic film to the paper material.

17. The laminate of claim 13, in the form of a tape product that includes a bonding adhesive upon the second side of the paper material or the second side of the plastic film.

18. The laminate of claim 17, wherein the bonding adhesive is a water-moistenable adhesive, a pressure sensitive adhesive, or a heat activated adhesive.

19. The laminate of claim 13, further comprising a second paper material wherein the second side of the plastic film is corona discharge treated and adhesively cold laminated to the second paper material using a water-based adhesive and pressure to form a plastic-paper-plastic laminate, wherein the biocide is associated with the paper layer or with one of the water-based adhesives so that the plastic films protect and retain the biocide in the laminate.

20. The laminate of claim 13, wherein the paper material is a paper sheet, a pressed paper, or cardboard optionally provided with corrugations.

21. An organism-resistant package comprising the laminate of claim 13 that is configured and dimensioned as an envelope, packaging material, or container.

22. The package of claim 21, wherein the laminate is folded to form the envelope or container and a bonding adhesive is applied to one or more portions of the folded laminate to facilitate closure and sealing of the envelope or container.

23. The package of claim 21, wherein the paper material is a paper sheet, a pressed paper, or cardboard optionally provided with corrugations, and wherein the biocide is present in the laminate in the paper material, the water-based adhesive or the bonding adhesive.

24. An organism-resistant package comprising a container of a dilatable material which is configured and dimensioned to retain one or more articles therein and the tape product of claim 17 which is applied to the dilatable material to close and seal the article(s) therein, wherein the biocide assists in reducing or preventing contaminants from entering through the seal and into the package.

25. The package of claim 24, wherein the dilatable material is a cardboard box having flaps that are folded to form the box, the tape product is applied to secure the flaps and seal the articles in the box, and wherein the biocide is present in the laminate in the paper material or the water-based adhesive.

26. The package of claim 24, wherein the dilatable material is the paper-plastic laminate described above in the form of an envelope or container with the tape being integral therewith and forming a closing portion for the envelope or container.

27. The package of claim 24, which further comprises two superposed panels of the paper-plastic laminate which are marginally sealed together to define a pocket to accommodate the article(s).

28. The package of claim 24, wherein the dilatable material is the paper-plastic-paper laminate obtained by adhesively cold laminating a second paper material to the second side of the plastic film after corona discharge treatment, wherein the laminate is provided in the form of an envelope or container with the tape being integral therewith and forming a closing portion for the envelope or container, so that the paper-plastic-paper laminate can be marginally sealed together to define a pocket to accommodate the article(s).

29. The package of claim 24, wherein the paper material is a paper sheet, a pressed paper, or cardboard optionally provided with corrugations and wherein the biocide is present in the laminate in the paper material, the water-based adhesive or the bonding adhesive.
